(19) United States
(12) Patent Application Publication
(10) Pub. No.: US 2016/0320317 A1
(43) Pub. Date: Nov. 3, 2016

(54) High Sensitivity Tunable Radio Frequency Sensors

(71) Applicant: Clemson University, Clemson, SC (US)

(72) Inventors: Pingshan Wang, Central, SC (US); Yan Cui, Central, SC (US); Yongzhi Shao, Central, SC (US); Zhe Chen, Central, SC (US); Chao Shen, Tallahassee, FL (US)

(21) Appl. No.: 15/142,762

(22) Filed: Apr. 29, 2016

Related U.S. Application Data
(60) Provisional application No. 62/155,031, filed on Apr. 30, 2015.

(51) Int. Cl. G01N 22/00

(52) U.S. Cl. CPC G01N 22/00

(57) ABSTRACT

Systems and methods of determining characteristics of a material under test using highly sensitive, tunable RF sensors are disclosed. For instance, an RF sensor can include one or more interferometers having a reference branch and a test branch. The test branch includes a microstrip resonator and a coupled line filter. The RF sensor can further include a first port associated with each of the one or more interferometers configured to separate signals between a first transmission line and a second transmission line operable to provide a test signal to the resonator. and filter. The RF sensor can further include a signal analyzer coupled to the first port of the one or more interferometers operable to measure one or more scattering parameters. Wherein at least one of the one or more scattering parameters is indicative of one or more characteristics of a dielectric material disposed on the coupled line filter.

### PRIORITY CLAIM

The present application claims the benefit of priority of U.S. Provisional Patent Application No. 62/155,031, titled High Sensitivity Tunable Radio Frequency Sensors, filed Apr. 30, 2015, which is incorporated herein by reference for all purposes.

### GOVERNMENT SUPPORT CLAUSE

This invention was made with government support under grant #1152892, awarded by The National Science Foundation, and grant #GM100480, awarded by The National Institutes of Health. The government has certain rights in the invention.

### FIELD

The present disclosure relates generally to radio frequency (RF, e.g. from 3 KHz to 300 GHz) sensors. More particularly, the present subject matter relates to highly sensitive and highly tunable radio frequency (RF) sensors that can be used in conjunction with microfluidic channels.

### BACKGROUND

Radio frequency (RF) sensors are used to characterize the electrical and magnetic properties of materials, including the properties of fluids, thin films, molecules, particles, biological cells, tissues and organs. For instance, RF sensors are critical for electron paramagnetic (spin) resonance spectrometers (EPR/ESR) and dielectric spectrometers (DS), including EPR/ESR and DS imaging systems. These sensors usually operate at transmission, reflection, or resonance modes. In particular, RF sensors can be used to obtain information about a material-under-test (MUT). Such information can be obtained from measuring dielectric properties of a MUT. Highly sensitive and tunable RF sensors have been developed having an effective quality factor of 3.8×10⁶ and a frequency tuning range from approximately 20 megahertz to 38 gigahertz.

Such high sensitivity can require a signal detection instrument associated with the sensor (e.g. vector network analyzer) to have a large dynamic range (DR). For instance, a network analyzer may need to operate at a DR better than 120 dB. Such large dynamic range can cause environmental interference, such as mechanical vibrations and/or scattered RF radiations, which can destabilize interferometer operations.

Thus, a need exists for a simple, robust RF sensor that can simultaneously provide both increased sensitivity and lower system DR requirements.

### SUMMARY

Aspects and advantages of embodiments of the present disclosure will be set forth in part in the following description, or may be learned from the description, or may be learned through practice of the embodiments.

One example aspect of the present disclosure is directed to an RE sensor. The RF sensor includes one or more interferometers having a reference branch and a test branch. The test branch includes a microstrip resonator and coupled line filter. The RF sensor further includes a first port associated with each of the one or more interferometers. The first port is configured to separate signals between a first transmission line associated with the reference branch and a second transmission line associated with the test branch. The second transmission line is operable to provide a test RE signal to the microstrip resonator and coupled line filter. The RE sensor further includes a signal analyzer coupled to the first port of each of the one or more interferometers. The signal analyzer is operable to measure one or more scattering parameters. At least one of the one or more scattering parameters is indicative of characteristics of a dielectric material disposed on the coupled line filter.

Other example aspects of the present disclosure are directed to systems, apparatus, tangible, non-transitory computer-readable media, user interfaces, memory devices, and electronic devices for determining characteristics of a dielectric material.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example schematic block diagram of an example RF system according to example embodiments of the present disclosure;

FIG. 2 depicts an example schematic block diagram of a vector network analyzer according to example embodiments of the present disclosure;

FIG. 3 depicts an example filter/resonator test configuration according to example embodiments of the present disclosure;

FIG. 4 depicts an equivalent circuit configuration of an example coupled line filter according to example embodiments of the present disclosure;

FIG. 5 depicts a chart of example transmission coefficient magnitudes according to example embodiments of the present disclosure;

FIG. 6 depicts a chart of example propagation constants according to example embodiments of the present disclosure;

FIG. 7 depicts a chart of example measured group delays according to example embodiments of the present disclosure;

FIG. 8 depicts a chart of example transmission coefficient magnitudes according to example embodiments of the present disclosure;

FIG. 9 depicts a chart of example measured sensitivity according to example embodiments of the present disclosure;

FIG. 10 depicts a chart of example interferometer responses according to example embodiments of the present disclosure;

FIG. 11 depicts a chart of example interferometer sensitivity according to example embodiments of the present disclosure;

FIG. 12 depicts a top view and across sectional view of an example liquid-based attenuator according to example embodiments of the present disclosure;

FIG. 13 depicts a chart of example measured |S21|ₘᵢₙ for various lossy liquid amounts in a liquid-based attenuator according to example embodiments of the present disclosure;

FIG. 14 depicts an example filter according to example embodiments of the present disclosure;

FIG. 15 depicts an example filter according to example embodiments of the present disclosure; and

FIG. 16 depicts a flow diagram of an example method of determining one or more characteristics of a material under test according to example embodiments of the present disclosure.

### DETAILED DESCRIPTION

Reference now will be made in detail to embodiments, one or more examples of which are illustrated in the drawings, Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to highly sensitive and tunable RF sensors. The RF sensors are configured as tunable interferometers, which have two branches. In various embodiments, the two branches do not have to be identical. For instance, the branches can include a reference branch and a test branch. One or more signals can be passed through the two branches of the interferometer. More specifically, signals entering the RF sensor at a first port are divided by a first power divider or quadrature hybrid and sent through separate transmission lines (e.g. branches). The signals are tuned using various tuning components, such as attenuators and phase shifters, to provide a defined phase shift and magnitude balance between the two branches.

The test branch can be configured to include one or more filters and/or resonators. For instance, the test branch may include a coupled line filter and microstrip resonator configuration. In some implementations, the reference branch can include one or more filters and/or resonators as well. For instance, the reference branch can include an identical filter and/or resonator configuration as the test branch or other filter and/or resonator configuration. The test branch can further include a dielectric material disposed on the coupled line filter. ho example embodiments, the dielectric material can be the material on which tests are performed (e.g. material-under-test, (MUT)). Incorporating a coupled line filter and/or microstrip resonator into the interferometer can enhance the RF sensitivity of the interferometer (e.g. relative to a coplanar waveguide-based interferometer). In particular, strong interactions between the RF probing fields and the MUT are essential for higher sensitivities. For a given RF probing power and MUT volume, the interaction is determined by the interaction time and the local RF field intensity (e.g. the magnitude of the electric field and/or magnetic field). To extend the interaction time, slow wave structures can be used. Such extension can also be understood as an effective increase of the RF field intensities in traveling wave structures. The strengthened interactions between the RF fields and the MUT can boost the MUT signals and can reduce the required dynamic range, thereby increasing interferometer sensitivity.

In various implementations, interferometer sensitivity can be boosted using both stop-bands and pass-bands of the filters. For instance, to generate strong MUT-RF interactions in a filter stop-band, RF fields at the MUT location should be enhanced with an extended MUT-RF interaction time. It will be appreciated that such, techniques are filter specific, and can vary depending on one or more filter characteristics. The filed distributions and dispersion relationships are different in filter stop-bands and filter pass-bands. Additionally, the RF probing signal paths can be different, which will cause interferometer sensitivity and operating frequency differences. Such differences can be advantageous in certain applications as they can offer spatial and frequency differentiations.

The separated signals then exit corresponding channels and are recombined at a second power divider, or quadrature hybrid, and exit the RF sensor at a second port. A network analyzer can be configured to measure the transmission coefficient (S₂₁) to evaluate characteristics of the MUT. Additionally, a plurality of tunable interferometers may be employed, each operating in different frequency bands such that information obtain from the plurality of interferometers may be combined to provide further information.

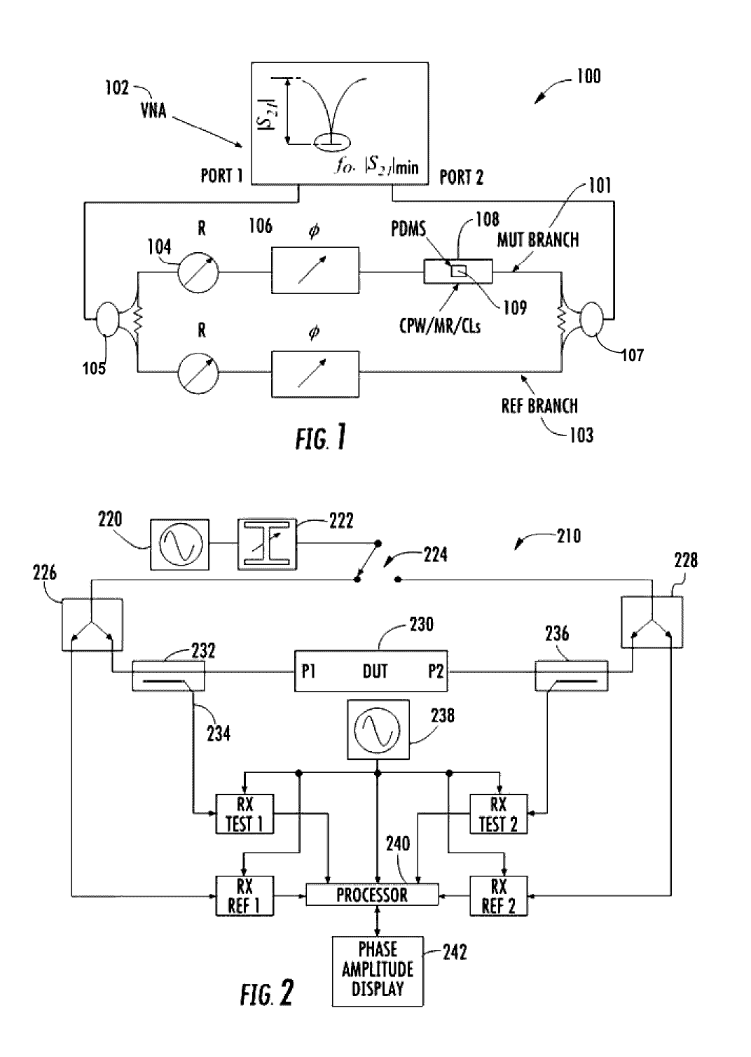

Referring now to the drawings, FIG. 1 depicts a schematic block diagram of an example RF sensor system 100 according to example embodiments of the present disclosure. RF sensor system 100 can be configured as an interferometer having a MUT branch (e.g. test branch 101) and a reference branch 103. RF sensor system 100 can include a vector network analyzer (VNA) 102. Energy in the form of a variable frequency signal from VNA 102 can be coupled to Port 1 and Port 2 of RF sensor system 100. Tuning elements 104, 106 (variable attenuator and phase shifter, respectively) are coupled in series. Additionally, in test branch 101, the tuning elements 104, 106 are coupled in series with a filter/resonator configuration 108. Such tuning elements 104, 106 can provide amplitude and phase adjustability, respectively, of RF signals traveling through RF sensor system 100.

Tuning elements 104, 106 can be any suitable tuning elements. For instance, in example embodiments the attenuators 104 can be liquid-based attenuators configured to provide minute, tunable attenuation of signals traveling through test branch 101 and reference branch 103. In alternative embodiments, liquid-based attenuators can be coupled to test branch 101 and reference branch 103 in addition to tuning elements 104, 106. Such liquid-based attenuators can facilitate higher sensitivity in RF sensor system 100. The control of the attenuation can be achieved, for instance, by adjusting liquid volumes in the attenuator above the transmission lines. In particular, a lossy liquid loaded in the attenuator can attenuate microwave magnitude. Such lossy liquid can include, without limitation, deionized water, ethanol, isopropanol, and/or various aqueous mixture solutions at different concentration levels.

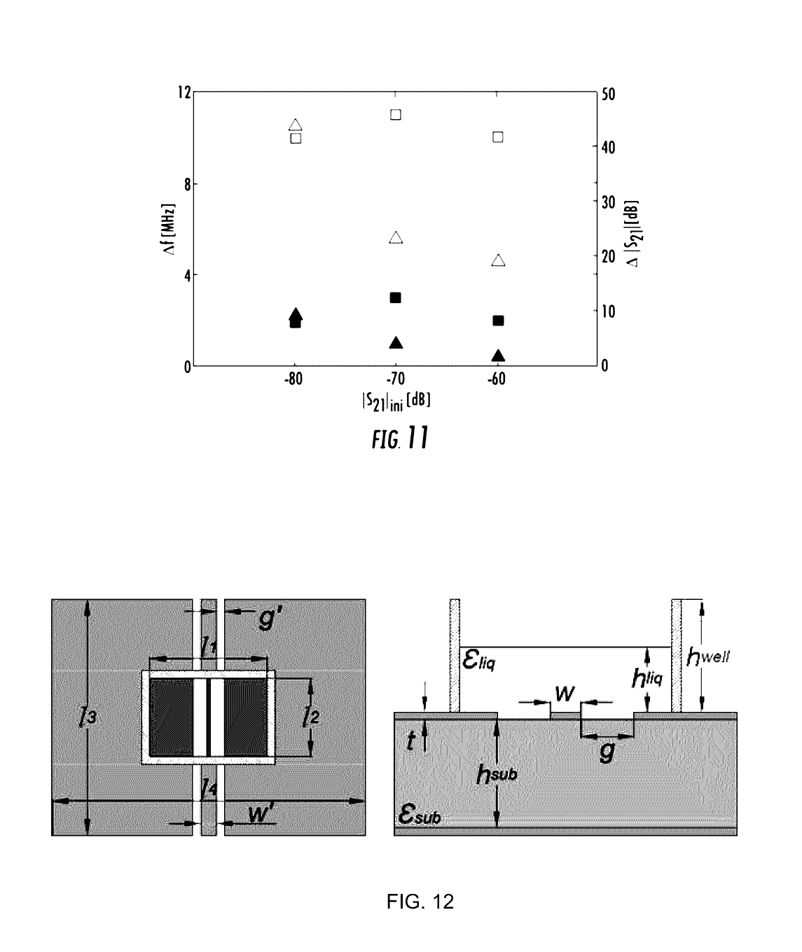

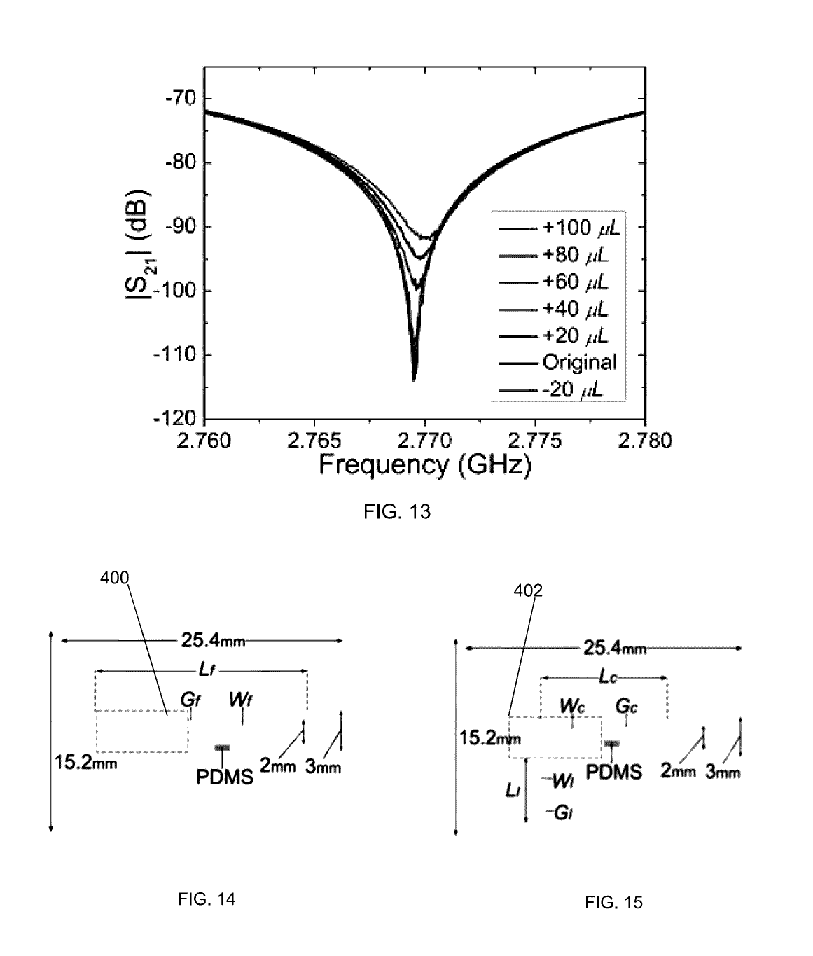

FIG. 12 depicts a top view (left) and a cross sectional view (right) of an example liquid-based attenuator according to example embodiments of the present disclosure. In example embodiments, the liquid based attenuator can include a conductor-backed CPW (e.g. grounded coplanar waveguide, GCPW) fabricated on a high frequency laminate. Such attenuator can have various suitable dimensions, such as for instance, the dimensions described in Table 1:

TABLE I
Dimension of Proposed attenuator

| Parameter | Symbol | Value | |
|---|---|---|---|
| Thickness of copper layer | t | 17 | μm |
| Thickness of substrate | h_{sub} | 0.787 | mm |
| Relative dielectric constant of | ∈_{sub} | 2.33 | |
| substrate | | | |
| Loss tangent of substrate | tanδ_{sub} | 0.0005 | |
| Relative dielectric constant of liquid | ∈_{liq} | 77.02 (at ~2.770 GHz) | |
| (water) | | | |
| Loss tangent of liquid (water) | tanδ_{liq} | 0.13 (at ~2.770 GHz) | |
| Width of well | l₁ | 15 | mm |
| Length of well | l₂ | 10 | mm |
| Depth of well | h_{well} | 20 | mm |
| Original depth of liquid (water) | h_{liq} | 10 | mm |
| Dimension of GCPW (in well) | g/w/g | 1.935/0.13/1.935 | mm |
| Dimension of GCPW (out of well) | g/w/g | 0.9/2.2/0.9 | mm |
| Length of attenuator | l₃ | 32 | mm |
| Width of attenuator | l₄ | 40 | mm |

Lossy liquid can be injected into the well of the attenuator prior to its operation. For instance, an amount of lossy liquid can be injected into the well corresponding to a depth of about 10 mm in the well. In example embodiments, attenuators 104 can be used to obtain an |S₂₁|ₘᵢₙ of about −95 dB at a selected frequency. Additional liquid can be incrementally added to adjust the |S₂₁|ₘᵢₙ. For instance, liquid can be added in increments of 20 microliters, and the |S₂₁|ₘᵢₙ can be measured after each addition until a desired |S₂|ₘᵢₙ is reached. It will be appreciated that various suitable incremental values can be used. Table II further describes the measured |S₂₁| values at the various liquid amounts:

TABLE II
Measured |S₂₁|ₘᵢₙ When 20 μL Water is Added at Each Step

| Total added volume | \|S₂₁\|ₘᵢₙ |
|---|---|
| of water (μL) | (dB) |
| +100 | −114.12 |
| +80 | −114.09 |
| +60 | −112.10 |
| +40 | −110.82 |
| +20 | −99.88 |
| 0 | −94.54 |
| −20 | −92.12 |

Referring back to FIG. 1, in some implementations, reference branch 103 can further include a filter/resonator configuration, such as filter resonator/configuration 108 or other filter/resonator configuration. test branch 101 can further include a dielectric material (e.g. MUT 109) disposed on filter/resonator configuration 108. In example embodiments MUT 109 can be, without limitation, polydimethylsiloxane (PDMS).

In example embodiments, RF sensor system 100 may include multiple interferometers selectively connectable by a switch configuration to VNA 102. For instance, RF sensor system 100 may include multiple pairs of interferometers, each configured to operate in a different frequency band range. In certain embodiments, for example, three sensors each operating in different bands may be employed, such as from 2.0 MHz-1 GHz, 1 GHz-18 GHZ, and 18 GHz to 40 GHz.

The signals entering the interferometer from Port 1 of VNA 102 are divided, by power splitting device 105. Power splitting device 105 can be, without limitation, a power divider or a quadrature hybrid. The divided signals are then sent through separate transmission lines (e.g. test branch and reference branch). Further, the signals are tuned by the attenuators and phase shifters to provide a defined phase shift and magnitude balance between the two branches. In one embodiment, for example, a 180° phase difference is provided between the reference and test branches to obtain high measurement sensitivity. More specifically, the 180° phase difference may be obtained by utilizing two 90° hybrids. The signals are then recombined by a second power splitting device 107 (e.g. hybrid) and enter the VNA at Port 2. In example embodiments, RF sensor system 100 can have an operating frequency f₀, at which the phase difference between the test branch and the reference branch satisfies (2n−1)π, for n=1, 2, 3, . . .

Referring to FIG. 2, a schematic block diagram of an example VNA 210 usable in combination with the RF sensor 100 of FIG. 1 is illustrated. VNA 210 can be employed to measure both amplitude and phase properties. The basic architecture of the VNA includes a signal generator, a test set, one or more receivers and a display. Additionally, most VNAs have two test ports permitting measurement of four scattering parameters or S-parameters (S₁₁, S₂₁, S₁₂, S₂₂). In accordance with the present subject matter, the forward voltage gain S₂₁ vs. frequency is used to determine cell characteristics.

Still referring to FIG. 2, the VNA 210 includes a variable frequency continuous wave (CW) source 220 whose output can be coupled through level adjustment device 222 and then through selection switch 224 to one or more splitters 226, 228. As shown, the switch 224 can be positioned so as to direct the output of source 220 in a forward direction through DUT 230 to enable measurement of S₂₁. Splitter 226 can divide the applied signal from source 220 between a reference path including reference receiver RX REF 1 and a test channel to Port 1 (P1) of the DUT 230 via directional coupler 232. An additional outlet 234 of directional coupler 232 couples power reflected from Port 1 (P1) of DUT 230 to a test receiver RX TEST 1.

Similarly, signals leaving Port 2 (P2) are coupled via directional coupler 236 to test receiver RX TEST 2. All of the receivers may be coherent receivers and share a common reference oscillator. As is well understood by those of ordinary skill in the art, all of the complex receiver outputs are fed to a processor 240. The processor 240 can mathematically process and display the chosen parameters and format on phase and amplitude display 242. In one embodiment, the display 242 can show waveforms indicative of one or more characteristics of MUT 109, as will be discussed in more detail below.

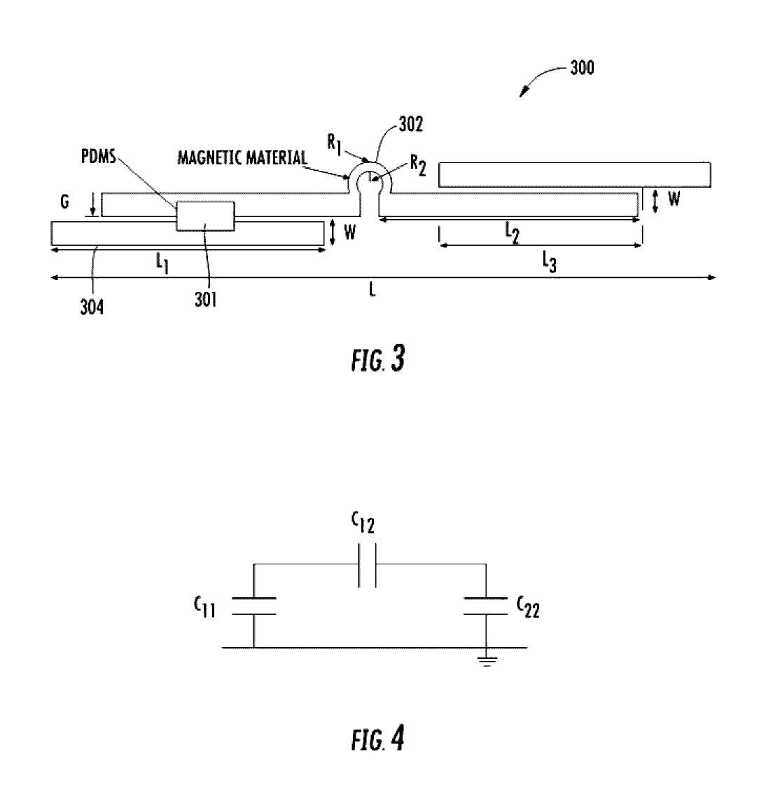

FIG. 3 depicts an example filter/resonator test configuration 300 according to example embodiments of the present disclosure. Test configuration 300 may include a coupled line filter and a microstrip resonator, In particular, test configuration 300 may include a planar split ring resonator 302. Edge coupling, as opposed to end coupling, can be used to achieve a lower insertion loss at a targeted frequency (e.g. approximately 2 GHz). Resonator 302 can be configured to generate strong RF magnetic fields in the ring area for paramagnetic material characterizations. Resonator 302 can have an inner radius of about 1 mm, and an outer radius of about 2 mm. As used herein, the terms “about,” and “approximately” when used in reference to a numerical value, are intended to refer to within 20% of the numerical value. It will be appreciated that resonator 302 may have other suitable size configurations. In example embodiments, resonator 302 can be configured for local RF electric field enhancement and group delay manipulation to boost interactions between the RF electric fields and dielectric materials (e.g. MUT 301). As indicated above, MUT 301 can be PDMS, a material commonly used for biomedical applications, having easily controlled dimensions. MUT 301 can be used to test and evaluate sensitivity improvements provided by test configuration 300.

Test configuration 300 can further include a coupled line filter 304. For instance, coupled line filter 304 can be a simple, one-stage coupled line filter. Filter 304 can be configured to slow RF signals over a broad frequency range, in example embodiments, at 2 GHz, the length of the coupled lines can be λ/4. Narrow lines and narrow gaps can be employed to achieve better coupling efficiency and to improve interferometer sensitivities. In example embodiments, filter 304 and resonator 302 can be fabricated with RT/Duroid 5870 laminates, although other suitable materials can be used.

FIG. 4 depicts an equivalent circuit of coupled line filter 304 according to example embodiments of the present disclosure. Capacitor C₁₂ can correspond to electric field coupling between the two edges of the coupling lines. Such electric field coupling can correspond to interaction potentials between an RF signal and MUT 301. Accordingly, MUT 301, when covering the coupling edge, as shown in FIG. 3, can induce a large change of the effective permittivity, which can significantly boost the interferometer sensitivity.

The use of filters in RF communications systems is well known. In particular, filters may be used to engineer signal spectrum and dispersion. Filters can be designed and built with different spectrum and dispersion, including left-hand characteristics. RF probing wave characteristics can then be engineered accordingly. For instance, group delays, field distributions, and/or intensities of RF probing waves can be engineered in accordance with various filters.

It will be appreciated that various filter configurations may be used in accordance with the scope of the present disclosure. For instance, test configuration 300 may include, without limitation, a high-pass filter, elliptic low-pass filter, band-stop filter, and/or a coupled line band-pass filter. Additionally, the chosen filter may be a first order filter, second order filter, third order filter, etc.

For instance, FIG. 14 depicts an example filter 400 according to example embodiments of the present disclosure. Filter 400 can be implemented or included within, for instance, test branch 101 and/or reference branch 103 of FIG. 1. In particular, filter 400 is a low pass filter. The design of filter 400 can be determined to achieve a reasonable transmission coefficient in pass band with longer group delay and stronger local fields. In some implementations, a CPW based structure can be used to build filter 400. Filter 400 can have a pass band of between about GHz and about 3 GHz or other pass band. The pass band, together with its adjacent stop band can be used for |S₁₁|ₘᵢₙ measurements, and can be within the operating frequency of the circuit components of the system 100. In some implementations, filter 400 can include two back-to-back short-end CPW series stubs.

FIG. 15 depicts another example filter 402 according to example embodiments of the present disclosure. Filter 402 is a high pass filter, the design of which can be determined to achieve a reasonable transmission coefficient in pass band with longer group delay and stronger local fields.

The introduction of MUT 301 to the filter may not significantly change a signal's group delay, but can induce changes in transmission coefficient (S₂₁). In particular, changes in transmission coefficient can be very large relative to coplanar waveguide-based RF sensor systems.

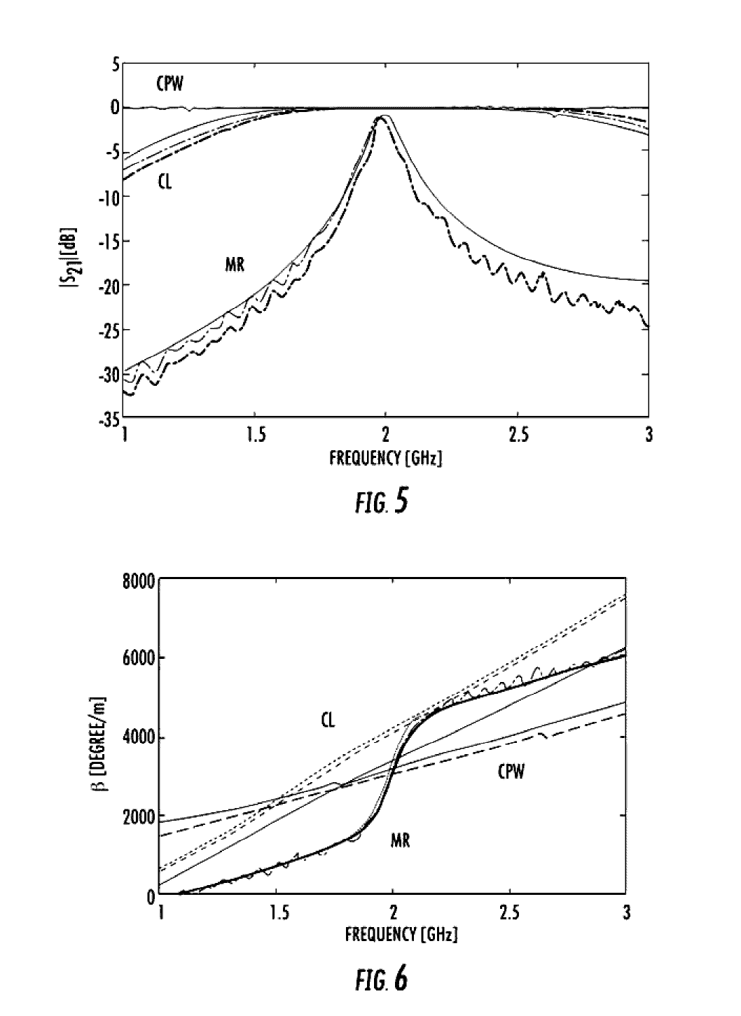

FIG. 5 depicts the transmission coefficient magnitudes (e.g. scalar linear gain |S₂₁|) over a range of frequencies of RF sensor systems having a coupled line filter, microstrip resonator and coplanar waveguide. In particular, FIG. 5 depicts the simulated (solid lines) and measured |S₂₁| with a PDMS slab (dotted lines) and without a PDMS slab (dashed lines). The simulations were conducted using high frequency structural simulator (HFSS), and generally agree with the measurement results. The quality factor for the microstrip resonator is about 20. Larger insertion loss (about −2 dB at an operating frequency of 2 GHz exists due at least in part to weak coupling. The |S₂₁| of the coupled line filter indicates a wider passband than that of the microstrip resonator. The addition of the PDMS slab only affects |S₂₁| slightly, as indicated in Table III below.

TABLE III

| f | Tested | \|S₂₁\| | Δ∠ S₂₁ | PDMS |
|---|---|---|---|---|
| [GHz] | Device | [dB] | [degree] | Size |
| 1.925 | MR | 0.28 | −1.8 | 1 |
| | CPW | <0.01* | −0.2 | |
| | MR | 0.83 | −5.0 | 2 |
| | CPW | 0.01 | −0.5 | |
| | MR | 1.74 | −11.3 | 3 |
| | CPW | 0.02 | −1.0 | |
| 1.9 | CL | 0.01 | −1.5 | 1 |
| | CPW | <0.01* | <0.1* | |
| | CL | 0.01 | −3.1 | 2 |
| | CPW | <0.01* | −0.1 | |
| | CL | 0.02 | −6.5 | 3 |
| | CPW | <0.01* | −1.1 | |
| 2.2 | CL | −0.05 | −1.4 | 1 |
| | CPW | <0.01* | −0.2 | |
| | CL | 0.05 | −2.8 | 2 |
| | CPW | <0.01* | −0.6 | |
| | CL | 0.07 | −6.3 | 3 |
| | CPW | 0.01 | −1.1 | |
| 2.5 | CL | 0.02 | −1.2 | 1 |
| | CPW | <0.01* | −0.2 | |
| | CL | 0.07 | −2.8 | 2 |
| | CPW | <0.01* | −0.7 | |
| | CL | 0.17 | −6.6 | 3 |
| | CPW | <0.01* | −1.2 | |

*Results are not repeatable

Table III describes PDMS induced S₂₁ changes at various specified frequency points. The PDMS sizes are 11.6×1.8×1.7 mm (size 1), 2.2×4.4×1.7 mm (size 2), and 4.1×7.0×1.7 mm (size 3). As shown, the larger PDMS slabs induce larger S₂₁ changes. For instance, a size 1 PDMS on the coplanar waveguide caused very small changes that are within measurement accuracy limitations. As expected, the microstrip resonator and coupled line filter exhibit much larger S₂₁ changes, with the resonator showing the largest effects. Accordingly, it is expected that the microstrip resonator and coupled line filter may significantly improve RF interferometer sensitivity.

FIG. 6 depicts propagation constants β obtained from HFSS simulations and measurements of a coupled line filter, microstrip resonator, and a coplanar waveguide. The introduction of the PDMS slab into the structures only affects the propagation constants slightly as indicated by the phase changes at the targeted frequency points in Table III.

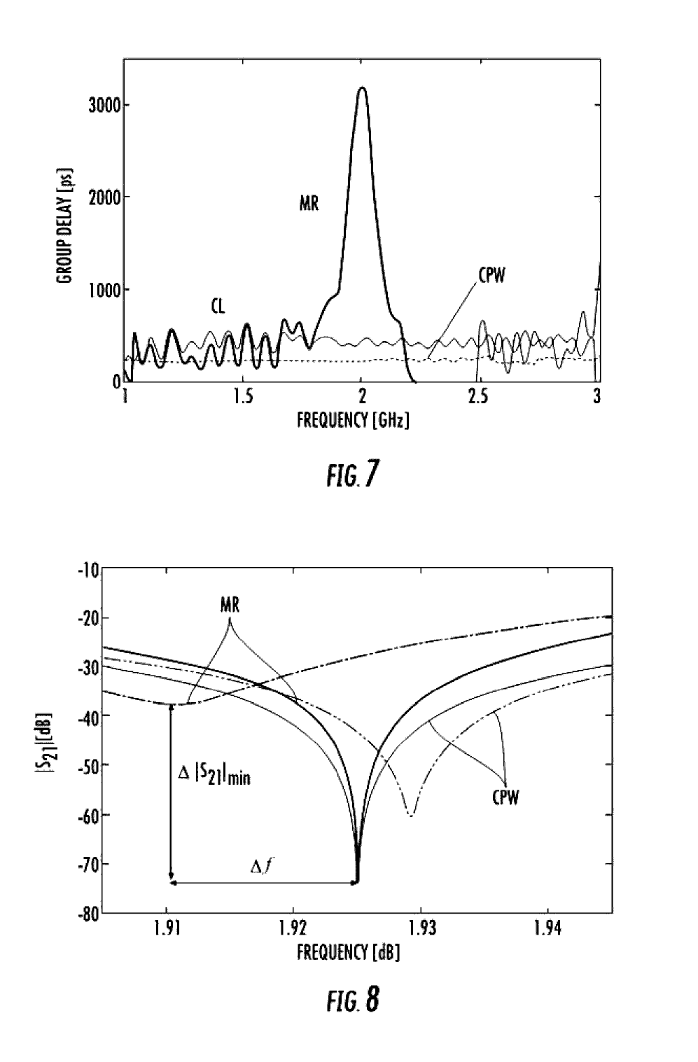

FIG. 7 depicts measured group delays, which are proportional to the slope of the measured propagation constants. Longer delays indicate longer time for RF probing signal to propagate from Port 1 to Port 2. Accordingly, as depicted, both the microstrip resonator and the coupled line filter can provide higher sensitivity in terms of operating frequency shift and |S₂₁| change at 2 GHz when compared with the coplanar waveguide.

FIG. 8 depicts a chart of S₂₁ of interferometers having a microstrip resonator and a coplanar waveguide. The interferometers may be tuned to have an initial S₂₁ of −70 dB. A PDMS slab may be placed on the coupling line gap of the microstrip resonator/coupled line filter, or of one of the line-ground gaps of the coplanar waveguide. The length of the PDMS can be parallel to the direction of the gap, such that the gap is fully covered.

As depicted in FIG. 8, the coplanar waveguide and the microstrip resonator induce frequency changes in different directions. The ratio is smaller than the phase change ratio in Table 1, which can be explained by group delay differences between the reference branch and the test branch. In the measurement frequency range (e.g. f₀=Δf), assume the phase of each branch is linear with frequency, which can be expressed as P=−Tf+b, where T is the total group delay of the branch, At f₀, we have P_{REF}−P_{MUT}=(2n−1)π.

After a MUT is loaded on the test branch, an extra phase difference between the test branch and the reference branch is introduced. The phase for the test branch is calculated as follows:

P_{MUT}=−T_{MUT}f+b_{MUT}+Δ∠S₂₁

Frequency shift is then calculated by:

Δf=f₀−f₀′=Δ∠S₂₁/(T_{REF}−T_{MUT})

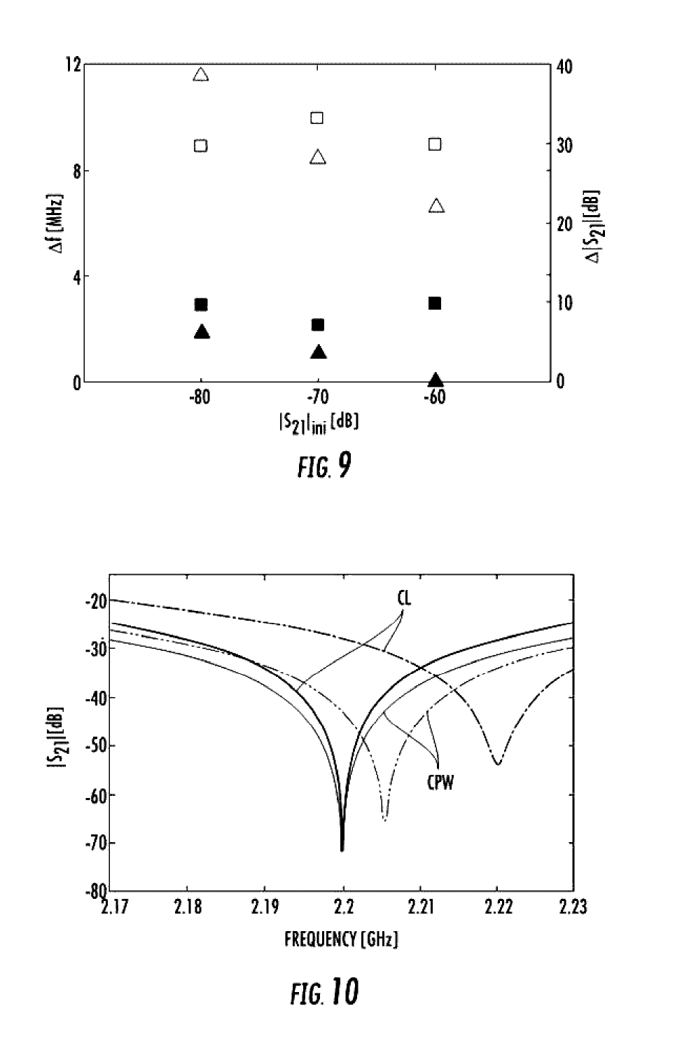

FIG. 9 depicts measured sensitivity dependence on initial |S₂₁|. In particular, FIG. 9 depicts measured frequency shift Δf (square) and Δ|S₂₁|ₘᵢₙ(triangle) at 1.925 GHz of a coplanar waveguide based interferometer (black) and microstrip resonator-based interferometer (white) with size 2 PDMS slab. As shown, the microstrip resonator induces a frequency shift of about 4 times that of the coplanar waveguide and up to 40 dB larger Δ|S₂₁|ₘᵢₙ. FIG. 9 also shows that Δf does not depend on initial |S₂₁| because Δf is associated with the phase difference of S₂₁. But minimum |S₂₁| does depend on initial |S₂₁|. In particular, a lower initial |S₂₁| can result in a larger minimum |S₂₁|.

FIG. 10 depicts interferometer responses with (dashed line) a size 2 PDMS slab and without (solid line) a size 2 PDMS slab for a coupled line filter-based interferometer and a coplanar waveguide-based interferometer. As shown, the coupled line filter structure yields a larger frequency shift and magnitude change.

FIG. 11 depicts effects of initial |S₂₁| interferometer sensitivity at 2.2 GHz with a size 2 PDMS slab. In particular, FIG. 11 depicts measured frequency shift (square) and Δ|S₂₁|ₘᵢₙ(triangle) of a coplanar waveguide-based interferometer (black) and a coupled line filter-based interferometer (white). Similar to FIG. 9, FIG. 11 indicates that frequency shift does not depend on initial |S₂₁|, while Δ|S₂₁|ₘᵢₙ does depend on initial |S₂₁|.

The process of magnitude changes can be analyzed as the following. Assume the |S₂₁| of the test and reference branches does not change in the vicinity of the operating frequency f₀. The magnitude of the two branches can be denoted as A₁(ω) and A₂(ω). Before a MUT is added on the device, initial |S₂₁| can be calculated as follows:

|S₂₁|ᵢₙᵢ=|A₁(ω₁)−A₂(ω₁)|/2

After the MUT is added the magnitude of the reference branch remains the same, while a change in magnitude is induced by the MUT in the test branch, denoted by |ΔA₁|. Therefore:

$$\begin{matrix}\vert {S}_{21} {\vert}_{{min}_{—} MUT} = \vert {A}_{1}^{′} ( {ω}_{2} ) - {A}_{2} ( {ω}_{2} ) \vert \text{/} 2 \\ = \vert {A}_{1}^{′} ( {ω}_{2} ) - {A}_{1} ( {ω}_{1} ) + {A}_{1} ( {ω}_{1} ) - {A}_{2} ( {ω}_{2} ) \vert \text{/} 2 \\ = \vert \vert Δ {A}_{1} \vert \text{/} 2 \pm \vert {S}_{21} {\vert}_{tot} \vert\end{matrix}$$

The change is calculated in decibels by:

$$Δ \vert {S}_{21} {\vert}_{min} = 20 log ( \frac{\vert {S}_{21} {\vert}_{{min}_{—} MUT}}{\vert {S}_{21} {\vert}_{tot}} )$$

Accordingly, it can be seen that both MUT and |S₂₁|ᵢₙᵢ will contribute to Δ|S₂₁|ₘᵢₙ.

As such, microstrip resonators and coupled line filters can significantly improve RF interferometer sensitivities. The resonators and filters, along with enhanced RF electric fields, can be exploited for high sensitivity magnetic material detection. In addition, the microstrip resonator and the coupled line filter can slow down RF wave propagations and enhance local RE fields relative to the performance of a coplanar waveguide based interferometer. As a result, interferometer sensitivities can be significantly enhanced.

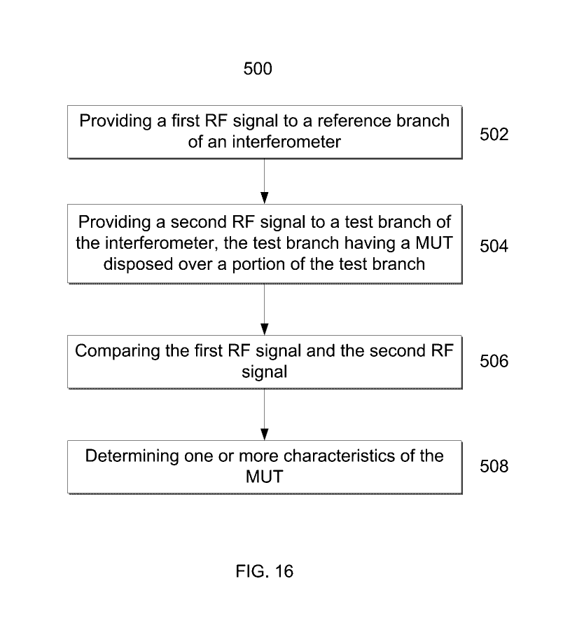

FIG. 16 depicts a flow diagram of an example method (500) of determining characteristics of a material under test (MUT) according to example embodiments of the present disclosure. FIG. 16 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (502), method (500) can include providing a first RE signal to a reference branch of an interferometer. At (504), method (500) can include providing a second RF signal to a test branch of the interferometer. For instance, providing the first and second RF signals to the reference branch and the test branch can include providing an RF signal to a power splitting device, such as a power divider or a quadrature hybrid device, coupled to the test branch and the reference branch. In particular, the power splitting device can be configured to divide a RF signal into a first and second RF signal, and to respectively provide the first and second RF signals to the reference and test branches of the interferometer.

The reference branch and the test branch can include one or more variable attenuators and/or one or more phase shifting devices. In some implementations, the variable attenuators can include piqued-based attenuators. The test branch can further include a resonator filter configuration, on which a Mil can be disposed. For instance, the resonator filter configuration can include a microstrip resonator and a coupled line filter (e.g. low pass filter, high pass filter, etc.). In some implementations, the reference branch can include a filter and/or resonator, such as an identical resonator filter configuration as the test branch or different configuration.

At (506), method (500) can include comparing the first RF signal and the second RF signal. For instance, comparing the first and second RF signals can include determining a phase of the first and second signals, and/or determining a phase difference between the signals. In some implementations, the first and second RF signals can be recombined by a quadrature hybrid or other device subsequent to an interaction between the second RF signal and the MUT. The recombined signal can be provided to a signal analyzer.

At (508), method (500) can include determining one or more characteristics of the MUT based at least in part on the comparison of the first and second RF signals. For instance, the one or more characteristics can include a permittivity and/or thickness of the MUT. As indicated, the MUT can be a dielectric material, such as a PDMS material.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An RF sensor comprising:
one or more interferometers having a reference branch and a test branch, the test branch comprising a microstrip resonator and coupled line filter;
a first port associated with each of the one or more interferometers, the first port configured to separate signals between a first transmission line associated with the reference branch and a second transmission line associated with the test branch, the second transmission line operable to provide a test RF signal to the microstrip resonator and coupled line filter;
a signal analyzer coupled to the first port of each of the one or more interferometers, the signal analyzer operable to measure one or more scattering parameters;
wherein at least one of the one or more scattering parameters is indicative of one or more characteristics of a dielectric material disposed on the coupled line filter.

2. The RF sensor of claim 1, further comprising a second port associated with each of the one or more interferometers, the second port configured to recombine signals from the first transmission line and the second transmission line, the second port being coupled to the signal analyzer.

3. The RF sensor of claim 1, further comprising one or more tuning devices implemented in the test branch.

4. The RF sensor of claim 3, wherein the one or more tuning devices comprise an attenuator and a phase shifter.

5. The RF sensor of claim 4, wherein the attenuator is a liquid-based attenuator.

6. The RF sensor of claim 1, wherein the coupled line filter comprises a low pass filter.

7. The RE sensor of claim 1, wherein the coupled line fitter comprises a high pass filter.

8. The RF sensor of claim 1, wherein the dielectric material comprises a polydimethyisiloxane material.

9. The RF sensor of claim 1, wherein the first port comprises a power divider or a quadrature hybrid power splitting device.

10. The RF sensor of claim 1, wherein the reference branch comprises at least one of a microstrip resonator or coupled line filter.

11. A method of determining characteristics of a dielectric material, the method comprising:
providing a first RF signal to a reference branch of an interferometer, the reference branch comprising one or more tuning devices;
providing a second RF signal to a test branch of the interferometer, the test branch comprising one or more tuning devices and a resonator filter configuration, wherein a dielectric material is disposed over at least a portion of the resonator filter configuration;
comparing the first RE signal and the second RF signal; and
determining one or more characteristics of the dielectric material based at least in part on the comparison of the first RE signal and the second RF signal.

12. The method of claim 11, wherein the resonator filter configuration comprises a microstrip resonator and a coupled line filter.

13. The method of claim 12, wherein the coupled line filter comprises a low pass filter or a high pass filter.

14. The method of claim 11, wherein comparing the first RF signal and the second RF signal comprises determining a phase of the first RF signal and a phase of the second RF signal.

15. The method of claim 11, wherein the one or more tuning devices of the reference branch and the one or more tuning devices of the test branch comprise a liquid-based attenuator.

16. The method of claim 15, wherein the liquid-based attenuator contains a lossy liquid, wherein the volume of the lossy liquid contained in the liquid-based attenuator is determined to substantially achieve a desired attenuation of the RF signal.

17. The method of claim 11, wherein the dielectric material comprises a polydimethylsiloxane material.

18. The method of claim 11, wherein providing a first RF signal to a reference branch of an interferometer and providing a second RF signal to a test branch of the interferometer comprises providing an RF signal to a power splitting device coupled to the reference branch and the test branch.

19. The method of claim 18, wherein the power splitting device comprises a quadrature hybrid device.

20. The method of claim 11, wherein the reference branch further comprises a resonator filter configuration.
